(19) United States
(12) Patent Application Publication
(10) Pub. No.: US 2025/0178498 A1
(43) Pub. Date: Jun. 5, 2025

(54) SEAT ELEMENT FOR A VEHICLE SEAT AND METHOD FOR PRODUCING A CORRESPONDING SEAT ELEMENT

(71) Applicants: Faurecia Autositze GmbH, Hannover (DE); INDORAMA VENTURES MOBILITY OBERNBURG GmbH, Obernburg (DE)

(72) Inventors: Mathieu Cluet, Etampes (FR); Benoît Gazaniol, Arpajon (FR); David Boudot, Magny-Vernois (FR); Michael Neidhöfer, Mainz (DE); Frank Leymann, Elsenfeld (DE)

(21) Appl. No.: 18/947,882

(22) Filed: Nov. 14, 2024

(30) Foreign Application Priority Data
Nov. 30, 2023 (DE) 10 2023 212 044.5

(51) Int. Cl. B60N 2/58

(52) U.S. Cl. CPC B60N 2/5891

(57) ABSTRACT

A seat element for a vehicle seat can comprise at least one carrier part with a first side and a second side opposite the first side, and one-piece, planar cushion mat with a first side and a second side opposite the first side, wherein the one-piece, planar cushion mat is produced from an elastic material comprising non-directionally arranged fibers. The first side of the one-piece, planar cushion mat is arranged at least in some regions on the first side of the carrier part and is elastically folded around a first edge of the carrier part so that the first side of the one-piece, planar cushion mat is arranged at least in some other regions on the second side of the carrier part and is fixed in an elastically folded form.

### CLAIM FOR PRIORITY

This application claims the benefit of priority of German Application No. 10 2023 212 044.5, filed Nov. 30, 2023, which is hereby incorporated by reference in its entirety.

### TECHNICAL FIELD

The present disclosure relates to a seat element for a vehicle seat and to a method for producing a corresponding seat element.

### BACKGROUND

Vehicle seats, such as for motor vehicles, aircraft, trains, or the like, have a frame, a plurality of cushion elements and a covering material. The cushion elements serve here in particular to provide an occupant with support and comfort. The cushions typically consist of a foam material, for example formed from polyurethane foam or for example from injection-molded polyethylene.

### SUMMARY/OVERVIEW

Injection-molding methods, such as those discussed above, have the disadvantage that complex shapes with undercuts cannot be produced in one piece. Furthermore, foam materials may, for example, have a sensitive surface that may form cracks or develop damage under load. Additionally or alternatively, foam materials may have the disadvantage that they tear under a bending load around edges of the carrier part and are unable to be folded around edges.

The present disclosure relates to a seat element and methods of producing a seat element which addresses and avoids or at least minimizes these disadvantages.

The proposed seat element for a vehicle seat comprises at least one carrier part. The carrier part has a first side and a second side opposite the first side. The seat element further comprises a cushion mat. The cushion mat may, in particular, be formed in one-piece and may be planar. The cushion mat has a first side and a second side opposite the first side. The cushion mat may comprise in particular an elastic material or may be produced from an elastic material. The material may comprise non-directionally arranged fibers.

The first side of the cushion mat is arranged at least in some regions on the first side of the carrier part and is elastically folded around a first edge of the carrier part so that the first side of the cushion mat is arranged at least in regions likewise on the second side of the carrier part. The cushion mat is in particular fixed in the elastically folded form, for example by means of fastening elements.

In the present case, the expression “elastically folded” may be understood to mean that the cushion mat is bent, wherein a resultant bending load of the cushion mat lies below the elastic limit of the material of the cushion mat.

Due to the fixation in the elastically folded position, a load on the cushion mat by a mechanical stress may be maintained. When the fixation and thus the mechanical stress is removed, the cushion mat may substantially resume its original form, i.e., a form that the cushion mat had prior to the bending load.

The proposed seat element may have the advantage that the cushion mat is foldable around edges of the carrier part, wherein undercuts may also be covered by the cushion mat.

In one embodiment the cushion mat may comprise one or more fastening elements in regions arranged on the second side. The fastening element or the fastening elements may fix the cushion mats in their elastically folded state. For example, an adhesive may be applied between the carrier part and the cushion mat. Additionally or alternatively, clips and/or hooks and/or eyelets may be connected to the cushion mat and/or to the carrier part. An additional fastening of the cushion mat to the carrier part may be provided on the first side of the carrier part.

In one embodiment, the fastening elements may engage in one another form-fittingly in order to hold the cushion mat in its elastically folded state. For example, the cushion mat may comprise a first flap to be folded and a second flap to be folded. The flaps to be folded may be arranged and formed in such a way that, when the cushion mat is arranged on the carrier part, they fully or at least partially rest on the second side of the carrier part. The first and the second flap may have edges that, in the state folded around the carrier part, lie adjacently to one another directly or at a certain distance. As fastening element, a first edge of the first flap may, for example, have a shape that is complementary to a shape of a second edge of the second flap. For example, the first edge may have one or more protrusions that are arrangeable in one or more corresponding recesses so that they produce a form fit. The shape of the protrusions and recesses may correspond, for example, to a puzzle-piece shape. Additionally or alternatively, the first and/or second edge may have, as fastening element, interlocking hooks and/or hooks and associated eyelets and/or interlocking rails.

In one embodiment a fastening element or a plurality of or all fastening elements may be formed in one piece with the cushion mat. The fastening elements may be formed from the same material as the cushion mat. This may simplify the production and/or logistics of the seat element. For example, no additional parts have to be connected as fastening elements to the cushion mat in a production step. Rather, the fastening elements may already be formed in the cushion mat, for example by means of thermoforming. This may save time, additional production steps, logistical effort, in particular on account of few individual parts, and/or costs.

In one embodiment, the cushion mat may have a uniform thickness, in particular in a state of production. The cushion mat may be processed in order to give the cushion mat a specific shape. For example, heat and/or pressure may be applied to the cushion mat in a thermal tool in a mold. For example, the cushion mat may be shaped in a molding tool at a temperature of at least 140° C. and/or at least 150° C. and/or at least 160° C. For example, the cushion mat may be shaped in a molding tool at a temperature of at most 240° C. and/or at most 220° C. and/or at most 200° C. The cushion mat may be plastically deformed at least in some regions in the mold, in particular may have assumed the shape permanently after having been removed from the molding tool. In particular, after the shaping, the cushion mat may have local regions of different thickness.

The cushion mat may have at least two local regions of different densities. A region of lower density may be plastically deformed.

Regions of lower density may be formed as fold edges. In particular regions of the cushion mat of this kind may be arranged in the region of edges or undercuts or on edges of the carrier part. The cushion mat may have differently sized regions of different densities. Regions of higher density may, for example, form support portions compared to regions of lower density.

A density difference between the at least two local regions may be at least 5 kg/m3 and/or at least 10 kg/m3 and/or at least 15 kg/m3. A density difference between the at least two local regions may be at most 70 kg/m3 and/or at most 50 kg/m3 and/or at most 30 kg/m3. Regions of higher density may be more easily compressible than regions of lower density. The material of the cushion mat may, in particular, not be a foam material.

The carrier part may, in particular, be a plastics injection-molded part. The carrier part may comprise polyester-based plastics elastomers and/or polyamides and/or polyolefins and/or copolymers. The carrier part may, for example, be a carrier part of a seat region and/or a backrest and/or an armrest and/or a leg rest and/or a footrest of a motor vehicle seat.

In particular, the non-directionally arranged fibers of the cushion mat may be formed from polyester and/or from a polyester-based elastomer and/or from polyolefin or may comprise one or more of these materials. The fibers may consist of a material that contains a thermoplastic polymer. The fibers may, for example, comprise a material or consist of a material that contains least one thermoplastic polymer.

The fibers may be referred to as “endless” since their length may be significantly greater than their diameter. For example, the ratio between the length of the fibers and their diameter is at least 100, preferably 500 and even more preferably 1000. In addition, the diameter of the fibers may be between 0.2 mm and 2 mm, preferably between 0.3 mm and 1.5 mm. The fibers may be present in the form of a fiber tangle. The fiber tangle may be referred to as “three-dimensional”, in particular since the thickness of the obtained fiber tangle is not negligible since it is preferably much greater than the diameter of the fibers. In particular, the thickness of the obtained fiber tangle is at least 10 times, preferably at least 30 times, more preferably at least 50 times greater than the diameter of the fibers of the fiber tangle.

The fiber tangle may consist of melted fibers or comprise same, wherein the fibers form loops that are welded to one another.

The fiber tangle may have a bulk density of less than 30 kg/m3. Alternatively, the fiber tangle may have a bulk density of greater than or equal to 30 kg/m3, preferably greater than or equal to 35 kg/m3, more preferably greater than or equal to 45 kg/m3, and/or less than or equal to 70 kg/m3, preferably less than or equal to 55 kg/m3.

The space between the fibers of the fiber tangle that forms the cushion mat is preferably left free and filled only with air or another ambient gas. In other words: It may be advantageous not to fill the space between the fibers of the fiber tangle with a liquid material in the form of a gel or a liquefiable solid, which, for example, is poured between the fibers. By keeping the space between the fibers free, a particularly breathable cushion mat may be obtained, since the space between the fibers promotes air circulation in the cushion mat. In particular, such a cushion mat may have better breathability than a cushion part, in particular made of polyurethane foam. Such a cushion mat may also have the advantage that it absorbs significantly less moisture than a cushion part formed from polyurethane foam.

The cushion mat may have a substantially cuboid shape. In particular, the fiber tangle may have a thickness of greater than or equal to 60 mm and/or less than or equal to 200 mm.

The cushion mat may be elastically folded around a plurality of edges of the carrier part. For this purpose, the cushion mat may have several regions with one or more flaps that is/are folded around the corresponding edge.

The cushion mat may have incisions, in particular in order to be foldable along the shape of the carrier part.

In addition, the seat element may have a covering that is arranged on a side of the cushion mat facing the carrier part. The covering may comprise fabric and/or fleece and/or woven fabric and/or felt and/or leather and/or artificial leather.

Further layers may be arranged between the covering and the cushion mat and/or between the carrier part and the cushion mat, for example in the form of a spacer fabric.

In particular, the seat element may be a seat back, a seat pad, a headrest, an armrest or a leg rest.

The present disclosure further relates to a method for producing a seat element according to the above description. The method typically comprises the following steps
providing a cushion mat according to the above description, wherein the cushion mat is produced from an elastic material comprising non-directionally arranged fibers,
providing a carrier part according to the above description
placing the cushion mat on the carrier part in such a way that the first side of the cushion mat is arranged at least in some regions on the first side of the carrier part and is folded around a first edge of the carrier part, in particular elastically, so that the first side of the cushion mat is arranged at least in regions likewise on the second side of the carrier part and is fixed in the elastically folded form.

According to one embodiment, the method for forming the cushion mat may comprise one or more of the following steps:
extruding a material, which in particular comprises at least one thermoplastic polymer, through an extrusion die which comprises a plurality of die holes to form a curtain of melted fibers;
forming a tangle of melted fibers, wherein the fibers form loops that are welded to one another;
cooling the fiber tangle.

The curtain of melted fibers may be guided between two counter-rotating guide members. A fiber jam may form upstream of the two guide members, so that a tangle of fibers that form loops welded to one another is created.

Before the cushion mat arranged on the carrier part is attached thereto, the cushion mat may be shaped and/or cut to size. In particular, the cushion mat may be trimmed and/or shaped in a molding tool, in particular molded by means of heat and/or pressure, in particular at the temperatures and/or pressures described above.

Further advantages and/or features are explained in greater detail with reference to the following non-limiting description of exemplary embodiments and with reference to the accompanying drawings.

### BRIEF DESCRIPTION OF THE DRAWINGS

In the drawings:

FIGS. 1a to 1e show an exemplary embodiment of a vehicle seat pad in different perspectives,

FIGS. 2a to 2e show an exemplary embodiment of a vehicle seat backrest in different perspectives,

FIG. 2f shows the front side of the backrest shown in FIGS. 2a to 2e,

FIG. 3 shows a schematic representation of a vehicle seat backrest and an associated cushion mat,

FIG. 4 shows a schematic representation of an upper portion of an exemplary vehicle seat backrest with a cushion mat comprising fasteners,

FIG. 5 shows a schematic representation of an upper portion of an exemplary vehicle seat backrest with a cushion mat comprising flaps and fold regions,

FIG. 6 shows a further schematic representation of an upper portion of a vehicle seat backrest with a cushion mat comprising flaps,

FIG. 7 shows a schematic flow chart visualizing an exemplary production method for a seat element.

### DETAILED DESCRIPTION

Features described in relation to an exemplary embodiment of one figure may be applied to an exemplary embodiment of another figure, unless explicitly described to the contrary. Recurring features are provided with the same or similar reference signs in the following description.

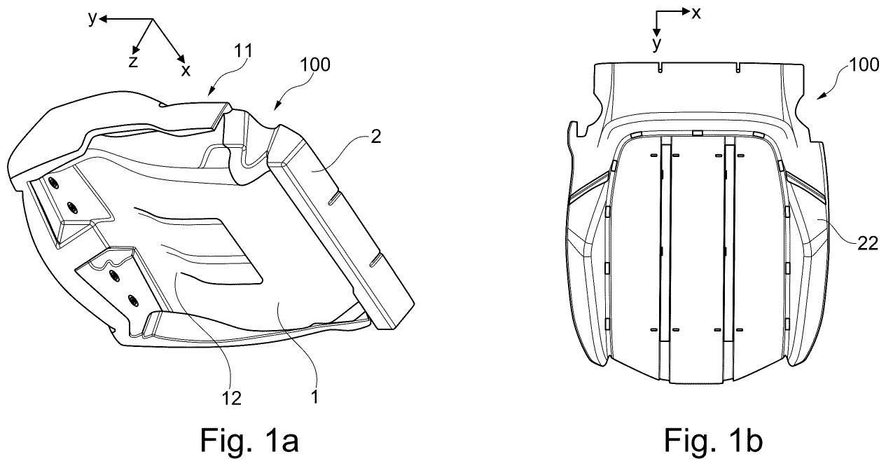

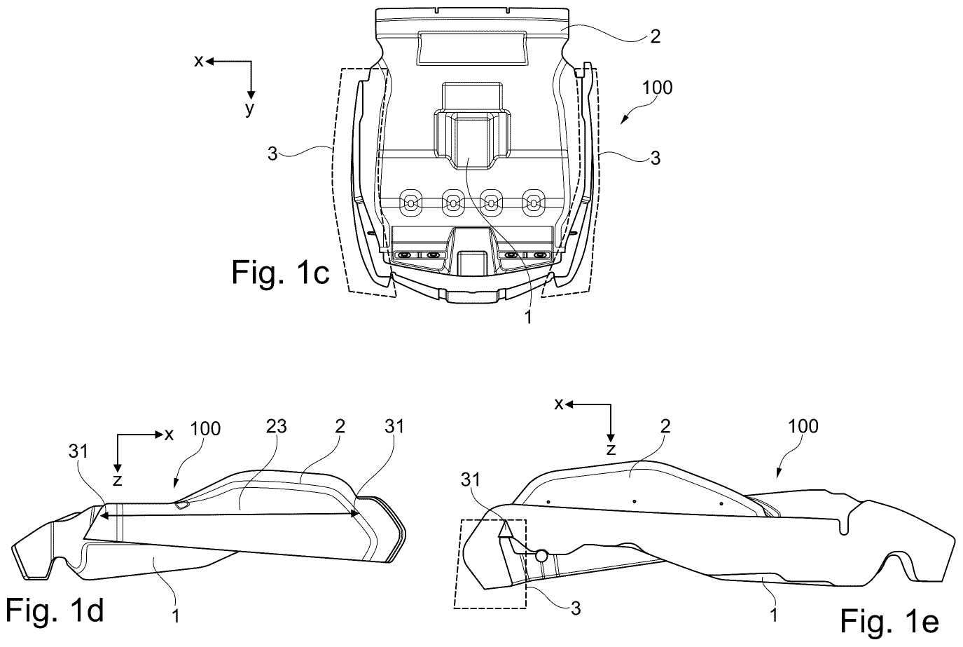

FIG. 1 shows a schematically illustrated seat pad 100 for a vehicle seat pad for a motor vehicle. FIG. 1a shows the seat pad 100 in a perspective view. FIG. 1b shows the seat pad 100 in a plan view. FIG. 1c shows the seat pad 100 in a view from below. FIG. 1d shows a side view of the seat pad 100. FIG. 1e shows a section in the xz plane through the seat pad 100. The seat pad 100 comprises a carrier part 1 and a cushion mat 2. The carrier part 1 has a first side 11 and a second side 12. When the seat pad 100 is installed in a vehicle, the first side 11 corresponds to the side on which a vehicle occupant sits, whereas the second side 12 corresponds to an underside that faces the vehicle floor. The first side 11 faces away from the viewer in FIG. 1a. The cushion mat 2 has a first side 21 and an opposite second side 22. The first side 21 lies flat on the first side 11 of the carrier part 1. Furthermore, regions of the cushion mat 2 protrude beyond the first side 11 of the carrier part and are folded around edges of the carrier part 1. In some regions, the first side 21 of the cushion mat 2 thus likewise lies also on the second side 12 of the carrier part 1. The second side 22 of the cushion mat 2 faces away from the carrier part 1. The cushion mat 2 may be elastically folded around the edges of the carrier part and fixed in this position. The fixation may be achieved, for example, by fasteners 4, which are described later separately. FIGS. 1c and 1e show regions 3 in which the cushion mat 2 is folded around edges of the carrier part 1. The sectional view in FIG. 1e shows that the cushion mat 3 surrounds undercuts of the carrier part 1. In FIG. 1e, an upper tip of the triangle 31 marks a fold edge 23 of the cushion mat 2, along which the cushion mat 2 is folded. FIG. 1d shows a further fold edge 23 which extends between the triangles 31. In the region of the fold edge 23, the cushion mat 2 may have a higher density than in a region surrounding the fold edge 23.

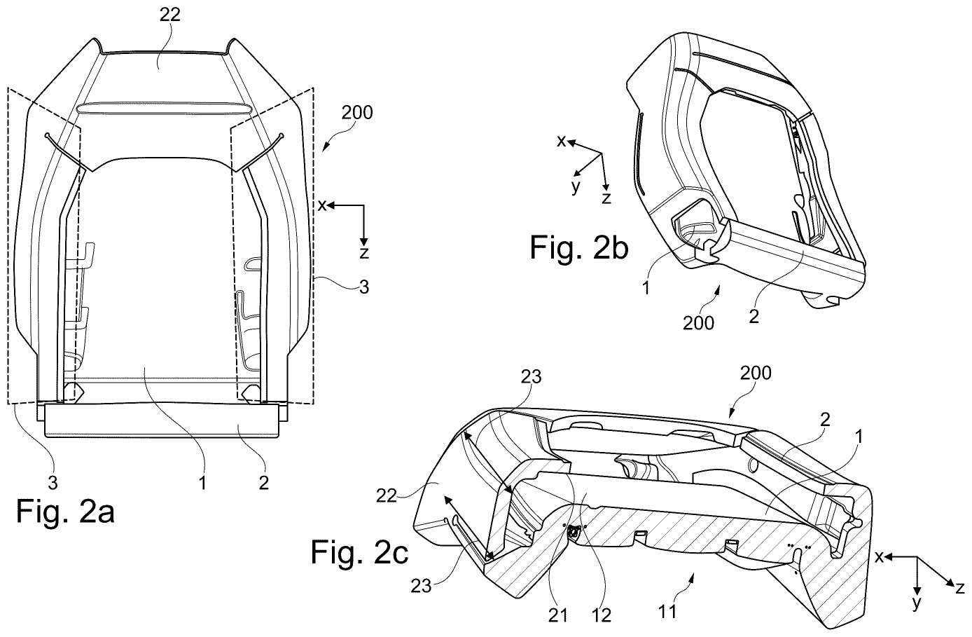

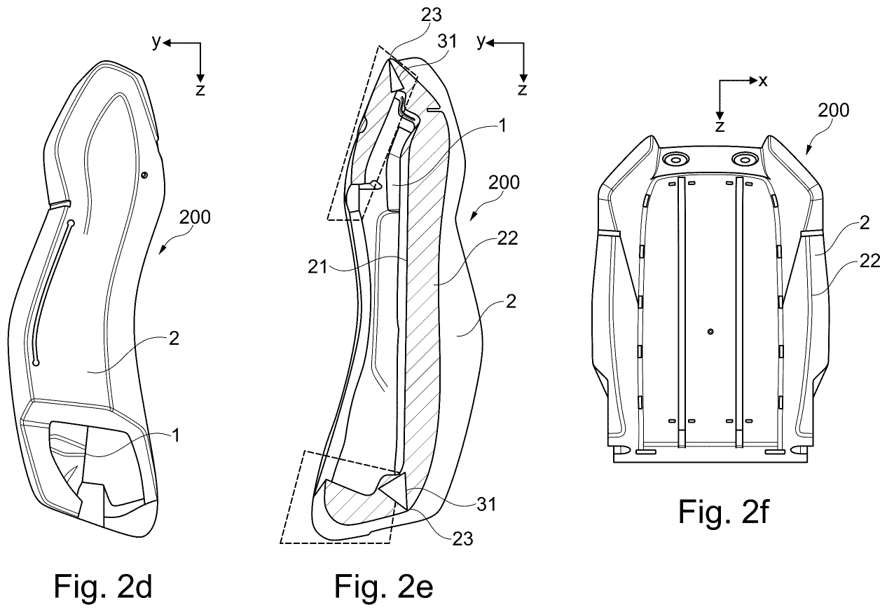

FIG. 2 shows a schematically illustrated backrest 200 for a vehicle seat for a motor vehicle. FIG. 2a shows a rear view of the backrest 200. FIG. 2b shows the backrest 200 in a perspective view from diagonally below. FIG. 2c shows the backrest 200 in a sectional view in a section parallel to the xy plane from below. FIG. 2d shows a side view of the backrest 200. FIG. 2e shows a section parallel to the yz plane through the backrest 200. The backrest 200 comprises a carrier part 1 and a cushion mat 2. The carrier part 1 has a first side 11 and a second side 12. When the backrest 200 is installed in a vehicle, the first side 11 corresponds to the side facing a vehicle occupant, whereas the second side 12 corresponds to a rear side facing away from an occupant seated in the vehicle seat. The first side 11 faces away from the viewer in FIG. 2a. The cushion mat 2 has a first side 21 and an opposite second side 22. The first side 21 lies flat on the first side 11 of the carrier part 1. Furthermore, regions of the cushion mat 2 protrude beyond the first side 11 of the carrier part and are folded around edges of the carrier part 1. In some regions, the first side 21 of the cushion mat 2 thus likewise lies also on the second side 12 of the carrier part 1. The second side 22 of the cushion mat 2 faces away from the carrier part 1. The cushion mat 2 may be elastically folded around the edges of the carrier part and fixed in this position. The fixation may be achieved, for example, by fasteners 4, which are described later separately. FIGS. 2a and 2e show regions 3 in which the cushion mat 2 is folded around edges of the carrier part 1, and FIG. 2f shows the front side of the backrest shown in FIGS. 2a to 2e. The sectional view in FIG. 2e shows that the cushion mat 3 surrounds the undercuts of the carrier part 1. The triangles 31 each mark a fold edge 23 of the cushion mat 2, along which the cushion mat 2 is folded around the carrier part 1. In the region of the fold edge 23, the cushion mat 2 may have a higher density than in a region surrounding the fold edge 23.

The cushion mat 2 of the seat pad shown in FIG. 1 and the cushion mat 2 of the backrest shown in FIG. 2 each have regions with different thicknesses. For example, the respective cushion mat 2 may be preformed in a molding tool so that it is adapted to the shape of the carrier element 1 and/or has support portions. The cushion mat 2 may be adhesively bonded to the carrier part 1, at least in some regions.

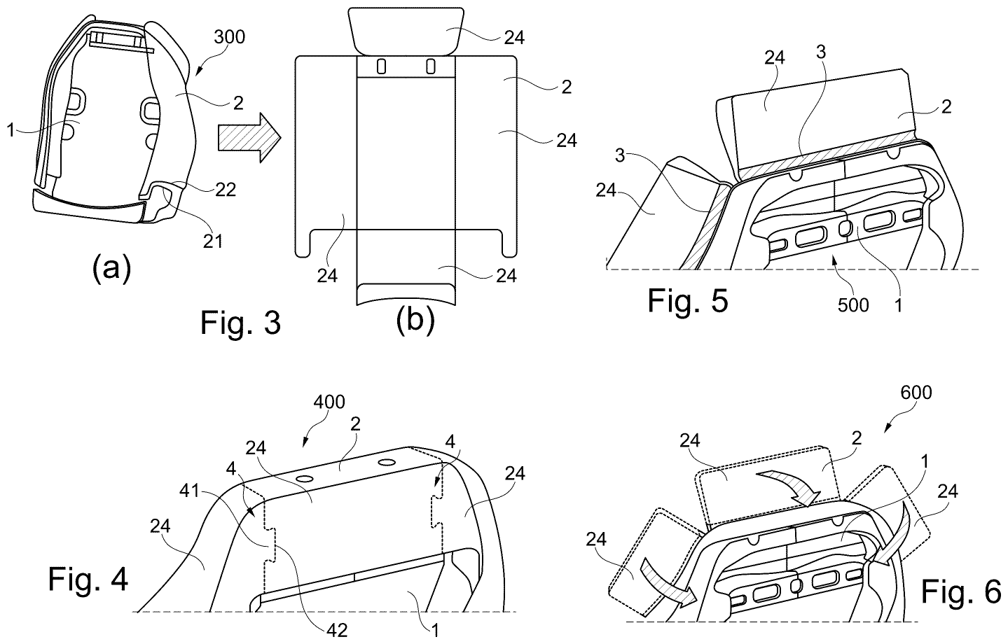

FIG. 3 shows a schematic representation of a vehicle seat backrest in a perspective view. The backrest 300 comprises a carrier part 1 and a cushion mat 2. The cushion mat 2 is arranged on the carrier part 1, wherein a first side 21 of the cushion mat 2 is arranged on a first side 11 and a second side 12 of the carrier part 1 opposite the first side 11. For this purpose, the cushion mat 2 has flaps 24, each of which is folded around an edge of the carrier part 1. In particular, the cushion mat 2 may have four flaps, wherein a first flap 24 in the upper region of the backrest is folded around the carrier part, two opposite, lateral flaps 24 are folded around lateral edges of the carrier part 1, and a lower flap 24 is folded around a lower edge of the carrier part 1. FIG. 3b shows the cushion mat 2 in an unfolded state. The cushion mat 2 may be transported in an unfolded state, for example, which may make logistics easier.

FIG. 4 shows an upper portion of a backrest 400 of a motor vehicle seat, wherein the backrest 400 has a carrier part 1 and a cushion mat 2 arranged thereon. The arrangement of the cushion mat 2 on the carrier part 1 substantially corresponds to the arrangement in FIGS. 3 and 2. FIG. 4 shows an exemplary fastening. The flaps 24 each have at least one outer edge, the shape of which corresponds to the shape of the respective adjacent outer edge of the adjacent flap 24. In particular, the outer edges have protrusions 241 with undercuts that engage in corresponding receiving recesses 242. In this way, a form fit may be formed between two adjacent flaps. The flaps 24 may be elastically folded under tension around the edges of the carrier part 1 and held in the folded shape by the form fit between the protrusions 41 and the receiving recesses 42. The protrusions 41 and receiving recesses 42 may be parts of fasteners 4. The fasteners 4, for example, in the form of the protrusions 41 and receiving recesses 42, may be separate parts which are fastened to the flaps 24 or, preferably, may be formed in one part with the flaps 24 and from the same material as the flaps 24. Alternative fasteners 4 are, for example, eyelets and/or hooks and/or rails and/or clamps.

FIGS. 5 and 6 each show an upper portion of a backrest 500 or 600 of a motor vehicle seat, wherein the backrest 500 or 600 in each case has a carrier part 1 and a cushion mat 2 arranged thereon. The arrangement of the cushion mat 2 on the carrier part 1 substantially corresponds to the arrangement in FIGS. 2, 3 and 4. FIG. 5 shows fold regions that have a lower thickness than the surrounding regions of the flap 24. The flaps 24 are folded around the carrier part 1 along these fold regions 3. The fold direction is illustrated again in FIG. 6 using the arrows.

The cushion mat 2 is formed by a fiber tangle. The cushion mat 2 comprises a three-dimensional (“3D”) tangle of endless fibers. The ratio between the length of the fibers and their diameter is at least 100, preferably 500, and even more preferably 1000. The diameter of the fibers is between 0.3 mm and 1.5 mm. The fiber tangle is referred to as “three-dimensional” since the thickness of the obtained fiber tangle is not negligible since it is preferably much greater than the diameter of the fibers. In particular, the thickness of the obtained fiber tangle is at least 50 times greater than the diameter of the fibers of the fiber tangle. The fibers here consist, for example, of a material that contains at least one thermoplastic polymer. For example, the fibers consist of a material containing at least 95% by weight of polyethylene terephthalate (or PET). For example, the fibers consist of a material that contains:
95% by weight to 99% by weight of a first polymer from the polyester family, such as PET; and
1% by weight to 5% by weight of a second polymer from the polyester family, such as polytrimethylene terephthalate (or PTT) or polybutylene terephthalate (or PBT). The material may be known in particular under the brand name “Auraloop”.

In addition to the cushion mat 2, the seat element may also comprise a covering that is intended to cover the cushion mat 2. This covering may be made from a single piece or from several pieces sewn together. The latter solution is preferred in order to best adapt the shape of the covering to the geometry of the cushion mat 2. This means that folds in the covering that covers the cushion mat 2 may be avoided as far as possible.

The covering may be fastened to the cushion mat 2 and/or the carrier part 1 by any means available to a person skilled in the art.

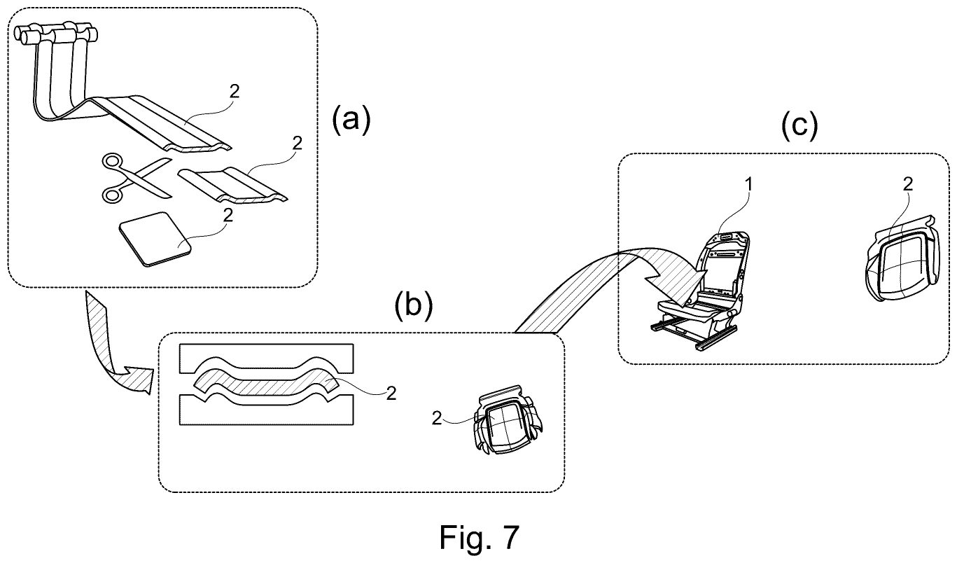

FIG. 7 shows an exemplary production method for producing a seat element according to the previous figures.

In a first step, shown in FIG. 7a, the fiber mat 2 is produced initially as a mat strip and shortened to form a fiber mat portion. In this method step, a preform of the fiber mat may already be formed, for example by rolling. In a subsequent method step 2, shown in FIG. 7b, the fiber mat 2 is placed in a molding tool, where it is heated and/or pressurized, for example in a mold. The fiber mat 2 may be further shaped in this step, in particular plastically deformed, and may permanently assume the shape specified by a tool mold.

For example, support portions and portions with increased density may be shaped. The fiber mat may be cut to size additionally or alternatively. After removing the fiber mat 2 from the molding tool, the fiber mat is in a shaped, unfolded state and may be packaged and transported. The fiber mat 2 may be applied to a carrier part 1 in a further step (shown in FIG. 7c). In particular, the fiber mat 2 may be folded around edges, in particular also around undercuts, of the carrier part 1, as already described above with reference to the preceding figures. The fiber mat 2 may be fixed in the folded state by fasteners 4 of the type described above. A covering may then be applied to the cushion mat.

What is claimed is:

1. A seat element for a vehicle seat, comprising:
at least one carrier part with a first side and a second side opposite the first side; and
a one-piece, planar cushion mat with a first side and a second side opposite the first side, wherein the one-piece, planar cushion mat is produced from an elastic material comprising non-directionally arranged fibers, and wherein the first side of the one-piece, planar cushion mat is arranged at least in some regions on the first side of the at least one carrier part and is elastically folded around a first edge of the at least one carrier part so that the first side of the one-piece, planar cushion mat is arranged at least in some other regions on the second side of the at least one carrier part and is fixed in an elastically folded state.

2. The seat element according to claim 1, wherein the one-piece, planar cushion mat, in the some other regions on the second side of the at least one carrier part, comprises one or more fastening elements, which fix the one-piece, planar cushion mat in the elastically folded state.

3. The seat element according to claim 2, wherein the one or more fastening elements engage in one another form-fittingly in order to hold the one-piece, planar cushion mat in its elastically folded state.

4. The seat element according to claim 2, wherein the one or more fastening elements are formed in one piece with the one-piece, planar cushion mat.

5. The seat element according to claim 1, wherein the one-piece, planar cushion mat has at least two local regions with different densities.

6. The seat element according to claim 1, wherein the non-directionally arranged fibers are formed from at least one of polyester, a polyester-based elastomer, or polyolefin.

7. The seat element according to claim 1, wherein at least one of: i) a ratio between a length of the non-directionally arranged fibers and a diameter of the non-directionally arranged fibers is at least 100, or ii) the diameter of the non-directionally arranged fibers is between 0.2 mm and 2 mm.

8. The seat element according to claim 7, wherein the ratio between the length of the non-directionally arranged fibers and the diameter of the non-directionally arranged fibers is 500.

9. The seat element according to claim 7, wherein the ratio between the length of the non-directionally arranged fibers and the diameter of the non-directionally arranged fibers is 1000.

10. The seat element according to claim 7, wherein the diameter of the non-directionally arranged fibers is between 0.3 mm and 1.5 mm.

11. The seat element according to claim 1, wherein the one-piece, planar cushion mat is elastically folded around a plurality of edges of the at least one carrier part.

12. The seat element according to claim 1, wherein the one-piece, planar cushion mat has one or more incisions.

13. A method for producing a seat element, the method comprising:
providing a cushion mat produced from an elastic material comprising non-directionally arranged fibers;
providing a carrier element; and
placing the cushion mat on the carrier element in such a way that a first side of the cushion mat is arranged at least in some regions on a first side of the carrier element and is elastically folded around a first edge of the carrier element so that the first side of the cushion mat is arranged at least in some other regions on a second side of the carrier element and is fixed in an elastically folded state.
